(19) United States
(12) Patent Application Publication
(10) Pub. No.: US 2006/0132349 A1
(43) Pub. Date: Jun. 22, 2006

(54) Radar detector with signal source location determination and filtering

(76) Inventors: Ari K. Stern, Owings Mills, MD (US); Audra R. Stern, Owings Mills, MD (US)

Correspondence Address: Arnold S. Weintraub;The Weintraub Group, P.L.C., Suite 240, 32000 Northwestern Highway, Farmington Hills, MI, 48334, US

(21) Appl. No.: 11/305,267

(22) Filed: Dec. 16, 2005

Related U.S. Application Data
(60) Provisional application No. 60/638,852, filed on Dec. 22, 2004.

(51) Int. Cl. G01S 7/40; G01S 13/42

(52) U.S. Cl. 342/20; 342/147

(57) ABSTRACT

A radar detector and location unit includes at least three sensors configured to detect a radar signal, at least three sensors being aligned in a non liner arrangement; a position receiver configured to determine a position of the radar detector; a data storage device configured to store data related to a location of a known series of radar emissions sites; a processor connected to the at least three sensors, the position receiver and the data storage device. The processor is configured to determine the location of the radar emission based on a coordination between the at least three sensors and the position of the radar detector. The processor is further configured to compare the location of the radar emission with locations in a known series of radar emissions sites.

### CROSS REFERENCE TO RELATED APPLICATION

This application is a completion application of copending U.S. Provisional Patent Application No. 60/638,852, filed on Dec. 22, 2004, the entire disclosure of which is hereby incorporated by reference.

### BACKGROUND OF THE INVENTION

1. Field of the Invention.

The present invention is for radar detectors. More specifically, the present invention is directed to a radar detector that can determine the location of a radar signal and filter the signal based upon a list of known false radar sources.

2. Prior Art.

Radar detectors warn drivers of the use of police radar, and the potential for traffic citations if the driver exceeds the speed limit. The FCC has allocated several regions of the electromagnetic spectrum for police radar use. The bands used by police radar are generally _{known} as the X, K and Ka bands. Each relates to a different part of the spectrum. The X and K bands are relatively narrow frequency ranges, whereas the Ka band is a relatively wide range of frequencies. By the early 1990's, police radar evolved to the point that it could operate almost anywhere in the 1600-megahertz wide Ka band. During that time radar detectors kept pace with models that include descriptive names like “Ultra Wide” and “Super Wide.” More recently, police have begun to use laser (optical) systems for detecting speed. This technology was termed LIDAR for “Light Detection and Ranging”.

Radar detectors typically comprise a microwave receiver and detection circuitry that is typically realized with a microprocessor or digital signal processor (DSP) Microwave receivers are generally capable of detecting microwave components in the X, K, and very broad Ka band. In various solutions, either a microprocessor or DSP is used to make decisions about the signal content from the microwave receiver. Systems including a digital signal processor have been shown to provide superior performance over solutions based on conventional microprocessors due to the DSP's ability to find and distinguish signals that are buried in noise.

Police use of laser has also been countered with laser detectors, such as those described in U.S. Pat. Nos. 5,206,500, 5,347,120 and 5,365.055. Products are now available that combined laser detection into a single product with a microwave receiver, to provide comprehensive protection.

The DSP or microprocessor in a modem radar detector is programmable. Accordingly, it can be instructed to manage all of the user interface features such as input switches, lights, sounds, as well as generate control and timing signals for the microwave receiver and/or laser detector. Early in the evolution of the radar detector, consumers sought products that offered a better way to manage the audible volume and duration of warning signals.

Methods for conditioning detector response are gaining importance, because there are an increasing number of signals present in the X, K and Ka bands from products that are completely unrelated to police radar. These products share the same regions of the spectrum and are also licensed by the FCC. The growing number of such signals is rapidly undermining the credibility of radar detector performance. Radar detectors cannot tell the difference between emissions from many of these devices and true police radar systems. As a result, radar detectors are increasingly generating false alarms, effectively “crying wolf”, and reducing the significance of warnings from radar detectors.

One of the earliest and most prevalent unrelated microwave sources is the automatic door system used in many commercial buildings such as supermarkets, malls, restaurants and shopping centers. The majority of these operate in the X-Band and produce signals virtually indistinguishable from conventional X-Band Police Radar. Other than the fact that door opening systems are vertically polarized, verses circular polarization for police radar, there is no distinction between the two that could be analyzed and used by a receiver design.

Until recently, virtually all of the door opening systems were designed to operate in the X-Band. As a result, radar detectors generally announced X-Band alerts far more often than K-Band. As these X-Band “polluters” grew in numbers, ultimately 99% of X-Band alerts were from irrelevant sources. X-Band alerts became meaningless. The only benefit that these sources offered the user was some assurance that the detector was actually capable of detecting radar. It also gave the user some intuition into the product's detection range. To minimize the annoyance to users, most radar detector manufacturers added a filter-like behavior that was biased against X-Band sources. Many also added “Band priority” that was biased against X and in favor of bands that were less likely to contain irrelevant sources such as K, Ka, and laser. If signals in both X and K Bands were detected, band prioritization would announce K, since it was more likely be a threat to the driver. In the last few years, K-Band door opening systems have also grown in number. This has reduced the significance of the K-Band warning and further undercut the overall benefit to the user of a radar detector.

Another unrelated microwave signal is generated by traffic management systems such as the ARTIMIS manufactured by TRW, based in Cincinnati, Ohio. ARTIMIS stands for “Advanced Regional Traffic Interactive Management and Information System”, and reports traffic flow information back to a central control center. Traffic congestion and other factors are analyzed by the control center. Control center employees use this information to formulate routing suggestions and other emergency information, which they transmit to a large distribution of overhead and roadside signs. In order to collect information on vehicle traffic, a roadside ARTIMIS station transmits an X-Band signal toward cars as they drive by. The ARTIMIS source, unlike the X-Band door opener systems, is distinguishable from police radar as it is not transmitted at a single fixed frequency. As a result, it is possible to differentiate police radar signals from sources such as ARTTMTS, and ignore ARTIMIS sources in newer detectors. Older detectors, however, do not incorporate this feature and could be obsolete in areas where ARTIMIS is in use.

Unrelated microwave signals are also transmitted by a system called the RASHID VRSS. Rashid is an acronym for “Radar Safety Brake Collision Warning System”. This electronic device warns heavy trucks and ambulances of hazards in their path. A small number of these RASHID VRSS units have been deployed. They are categorized as a member of the “non-stationary” set of unrelated sources. As in the ARTIMIS example, detection of RASHID can he prevented.

Perhaps the biggest source of non-stationary unrelated sources is from other radar detectors. These are sometimes referred to as “polluting radar detectors,” and present a serious threat to some detector products. An early example of this occurred in the mid 1980's when radar detectors using super homodyne circuitry became popular. Such detectors leak energy in the X-Band and K-Bands and appeared as police radar to other detectors. A similar problem occurred in the early 1990's when the Ka band was widened. An unexpected result was that the wider Ka band then, also, detected harmonics of signals generated by local oscillators within many existing radar detectors.

At this time, there are very few signal sources that can cause false laser detections in comparison to the substantial list of false microwave signals just described. However there are certain types of equipment that can cause the amplifiers and detection circuitry used in a laser detector to generate a “false” detect. In particular, certain locations near airports have been demonstrated to cause such problems for various laser detector products. As a result, selected airport environments are examples of stationary signals that produce false laser defections.

As can be appreciated from the foregoing example, as sources of unrelated signals continue to propagate, radar detectors must continually increase in sophistication to filter unrelated sources and accurately identify police radar. Each of these changes and enhancements has the potential effect of making obsolete existing detectors that do not include appropriate countermeasures. Furthermore, some sources, particularly, stationary door opener sources, at this time, cannot be filtered economically and, thus, threaten the usefulness of even the most sophisticated modem radar detector.

During the 1980's, the functionality of radar detectors expanded into other classes of driver notification. A system was developed that required a special transmitter be placed on emergency vehicles, trains, and other driving hazards. The term “emergency radar^{”} was coined, and a variety of products were introduced that could detect these transmitters. Another system was later introduced offering a larger class of “hazard categories” called the SWS system. Both emergency radar and SWS involve the transmission of microwave signals in the “K” band. Such signals are considered to be a part of the group of signal types that are intended to be detected by radar detectors.

A drawback of these warning systems is that stationary transmitters of these signals send the same message to drivers constantly, and become a nuisance during daily commute. This is beneficial to “new” drivers receiving the message for the first time. However these messages become an annoyance to drivers who follow the same path to work everyday.

Thus, radar detector manufacturers are continually confronted with new problems to solve, due to the variety of different types of unrelated sources and their sheer numbers. The rate at which new or upgraded radar detector models are introduced continues to increase as manufacturers try to evolve their products to manage the growing number of unrelated sources. Meanwhile, the market for radar detectors is shrinking because consumers are no longer interested in buying products that so quickly become obsolete.

### SUMMARY OF THE INVENTION

The present invention provides a radar detection system that filters out unrelated signals. The present invention comprises:

(a) at least three sensors configured to detect a radar signal, the at least three sensors being aligned in a non liner arrangement;

(b) a position receiver configured to determine a position of the radar detector;

(c) a data storage device configured to store data related to a location of a known series of radar emissions sites;

(d) a processor connected to the at least three sensors, the position receiver and the data storage device; and

wherein the processor is configured to determine the location of the radar emission based on a coordination between the at least three sensors and the position of the radar detector; and further

wherein the processor is further configured to compare the location of the radar emission with locations in the know series of radar emissions sites.

For a more complete understanding of the present invention; reference is made to the following detailed description and accompanying drawing. In the drawing like reference characters refer to like parts throughout the several views in which.

### BRIEF DESCRIPTION OF THE DRAWING

FIG. 1 is an environmental view showing the radar detector hereof in use;

FIG. 2 is a block diagram showing the component of the present detector;

FIG. 3 is a simplified block diagram of the device hererof;

FIG. 4 is a flaw diagram showing how the present detector functions; and

FIG. 5 is a view similar to FIG. 1 showing a vehicle including one embodiment hereof.

### DETAILED DESCRIPTION OF THE PREFERRED EMBODIMENTS

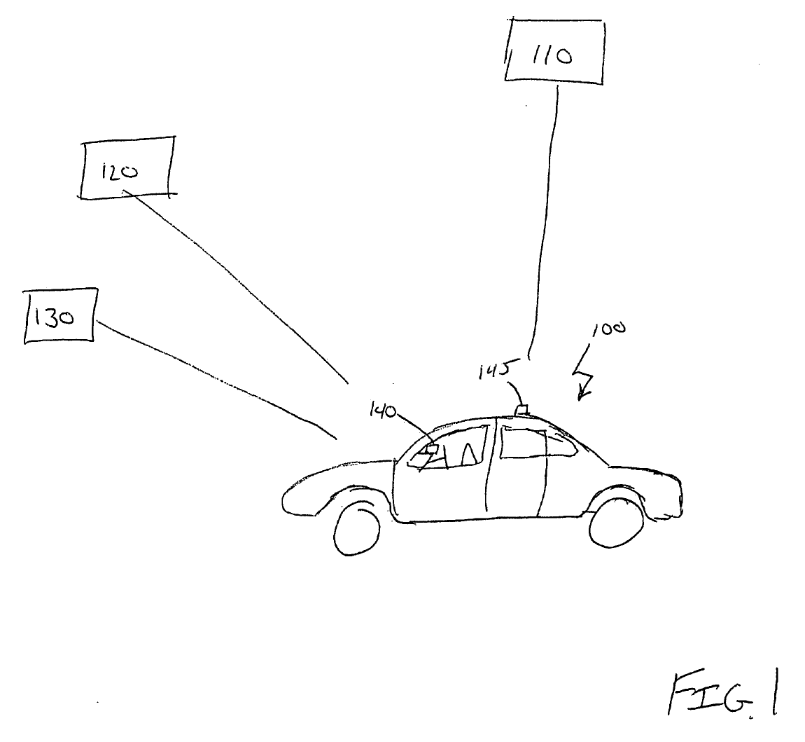

Referring now to FIG. 1, a vehicle 100 is illustrated in operation on a roadway, under exposure to a radio frequency signals from a variety of sources. These include a GPS satellite system 110, police radar signals from a radar gun 120, and non-police sources of interference 130. These non-police interference signals can be generated by a variety of sources such as automatic doors or security systems. Vehicle 100 also includes a radar detector 140 which is able to identify the present location and/or the velocity of the vehicle 100, using a GPS receiver 145 connected to the unit. However, other land-based signals such as LORAN can be used instead. The radar detector 140 uses this information to determine if the received signal is proper police signal 120 or is merely interference from a non police signal 130.

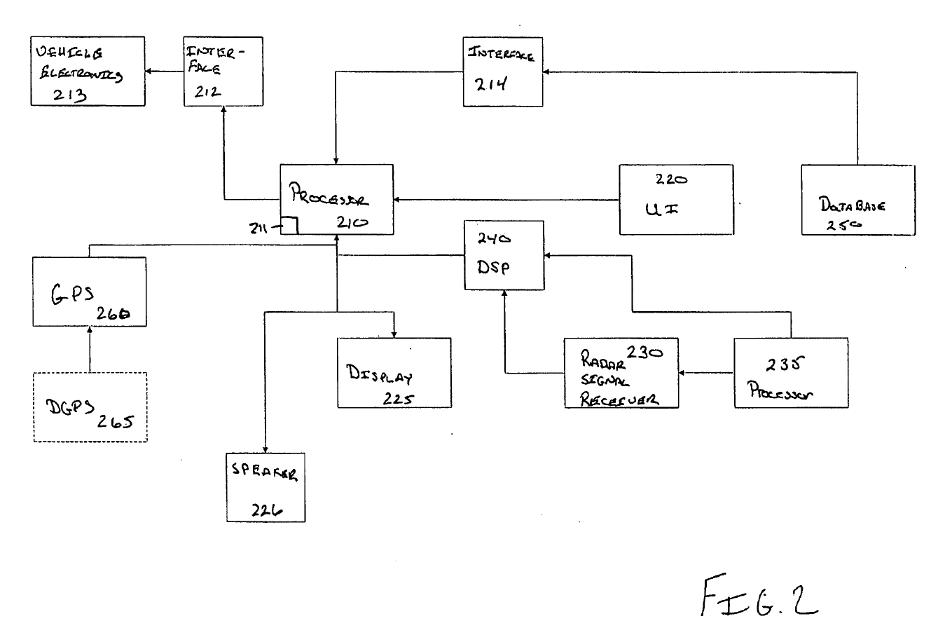

FIG. 2 is a block diagram illustrating the components of the radar detector 140 according to one embodiment of the present invention. Radar detector 200 corresponds to the detector 140 of FIG. 1 and includes a processor 210, a user input device 220, a display 225, a plurality of radar band receivers 230, a radar detection CPU 235, a digital signal processor 240, and a database of known radar locations 250.

The processor 210 controls the many functions of the radar detector 200. The processor 210 receives information on received radar signals from the plurality of radar band receivers 230. In one embodiment each radar band receiver 230 is a conventional microwave receiver that is tuned to identify X/K/Ka bands of radar. However, the plurality of radar receivers can be configured to identify other bands of radar or specific bands of radar. The receivers 230 are coupled to processor 210 through a digital signal processor (DSP) 240. Radar band receivers 230 and DSP 240 can utilize any known technique for rejecting noise and increasing discrimination between actual and spurious police radar signals. Further, receivers 230 and DSP 240 can he controlled by the radar detection CPU 235, which can enable additional signal evaluation beyond that which is possible using a DSP 240, or filter extraneous signals separately from the processor 210.

Processor 210 is further connected to a GPS receiver 260. In alternative embodiments an optional differential GPS (DGPS) receiver 265 (illustrated by dashed lines) can be used so that differential GPS can be used where beacon signals available.

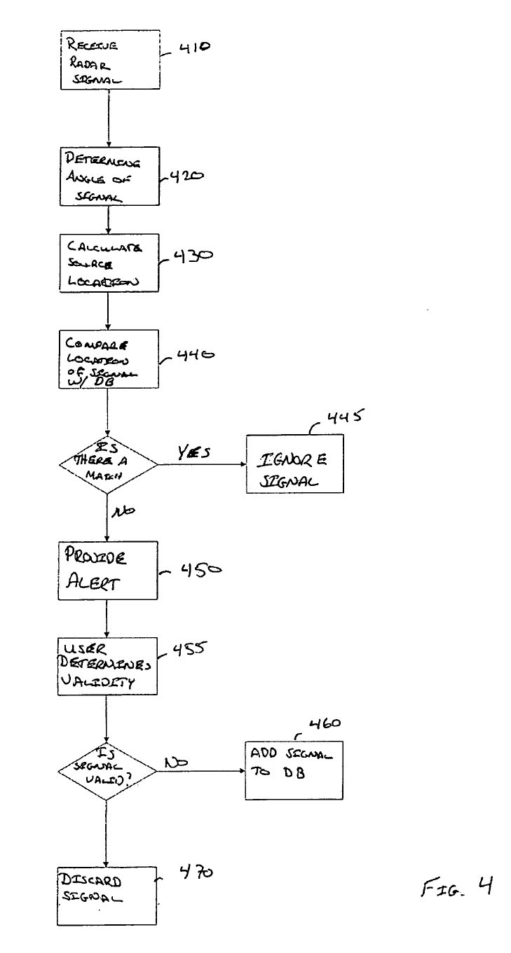

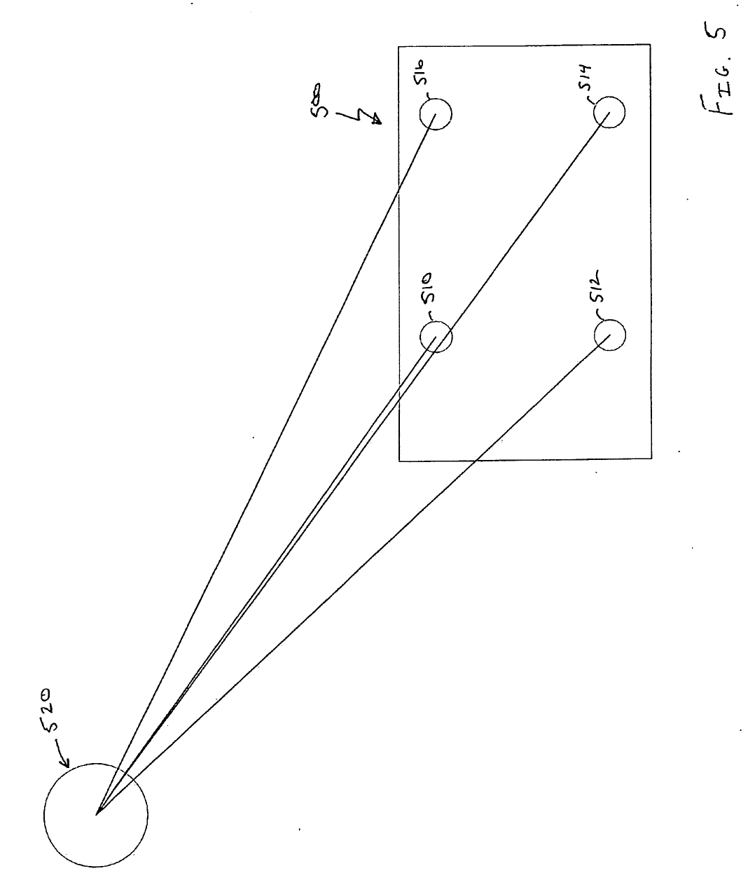

The processor 210 is configured to manage and report detected signals in various ways depending on the stored program 211, and information stored in database 250. This program 211 removes from the alert signals known false signals. The process of removing these signals will be discussed below with regards to FIGS. 4 and 5.

The radar detector 200 further incorporates a user input device 220. The user input device 220 illustratively can be a keypad, touch screen or switches. Operational commands can be input by the user to processor 210 through the user input device 220. Processor 210 is further connected to a display 225, which can include one or more light elements indicating various status conditions. In one embodiment, display 225 can include an alphanumeric or graphical display (such as a navigational map) that provides more detailed information to the user.

A speaker 226 is also provided to enable the processor 210 to deliver an audible tone to the user under various alert conditions.

Processor 210 can further include an interface 212, such as an ODB IT compliant interface, for connection to vehicle electronic systems 213 that are built into the vehicle 100. However, other interfaces 212 can be used. Most vehicles manufactured today are equipped with standardized information systems using the so-called OBD IT standard interface. Processor 210 can use the interface 212 to obtain vehicle speed or other vehicle status information directly from the vehicle, as opposed to obtaining this information via GPS.

Processor 210 is also coupled to an interface 214 that provides a means for uploading and downloading information to and from processor 210 and database 250. In one embodiment interface 214 is accomplished through a USB interface. However other types of interfaces can be used, such as firewire, bluetooth, or serial. Specifically, interface 214 can be used to automate the assimilation of coordinate information into data structures in database 250 on memory device. Interface 214 can also be used to interface the detector 200 with a separate computer or device having a larger storage capacity than available from internal memory. These components are not illustrated in FIG. 2 but are understood to be present. The computer or other connected device does not have to be visible to the driver and can be located in any location on the vehicle, such as under the driver seat.

Coordinate information can be stored related to locations of known signals are stored in database 250. As discussed above database 250 can be stored on a hard drive. Database 250 can be organized as an indexed database structure to facilitate rapid retrieval of the coordinates, and the hard drive may include a special purpose processor to enable rapid retrieval of this information.

Where database 250 is stored on a separate computer (not illustrated) and is connected via interface 214 various retrieval tasks can be assigned to the CPU of this computer rather than carried out on processor 210. In one embodiment this CPU can anticipate the need for information about particular coordinates based upon the vehicle 100 movements and location. The computer can then respond to this information by loading records for radar signal sources within a predetermined proximity to the current location to the database 250 to assist in faster processing times. The computer can also provide navigational functions to the driver, using navigational systems already present on the vehicle 100, or by using the stored signal information and locations to provide the user with location-specific information about driving hazards and potential police stakeout locations.

Data contained in the database 250 can be updated by downloading updates or additional locations of radar sources from other locations. For example, a connection can be established using interface 214 to an Internet site carrying radar signal source location information. For example, one update that is available is provided in a text format from speedtrap.com, an internet site containing a listing of known speed traps. An indirect internet connection can be established via the computer. Furthermore, connections may be established between two receivers, e.g. a trained receiver having extensive signal information, and a receiver having less extensive information, to transfer signal information between the receivers so that either or both has a more complete set of signal information. This information can be transmitted by any known wireless protocol such as GPRS. Further, information can be added to the database 250 using a CDROM, DVD or other portable storage devices.

In one embodiment, processor 210 determines the location of a received radar signal and compares the determined location with a stored list of the coordinates of unwanted stationary sources. If the radar detector receives a microwave/laser signal within a certain distance and direction of one of these pre-designated sources, processor 210 applies additional constraints to the detection criterion before alerting the user. Since stationary radar sources make up the bulk of the unwanted sources, there is a significant benefit resulting from these functions. The specific process taken by the radar detector 200 is discussed below. However, prior to proceeding a basic discussion of GPS will be provided.

The Global Positioning System (GPS) enables a GPS receiver to determine its relative location and velocity at any time the receiver has a relatively clear view of the sky. The GPS system is a worldwide constellation of 24 satellites and associated ground stations. GPS receivers on earth use “line of sight” information from these satellites as reference points to calculate positions to a high degree of accuracy often times to within a couple of feet. Advanced forms of GPS are able to determine location to an accuracy of a less than an inch. The Global Positioning System consists of three segments: a space segment of 24 orbiting satellites, a control segment that includes a control center and access to overseas command stations, and a user segment, consisting of GPS receivers and associated equipment. Over time GPS receivers have been miniaturized to just a few integrated circuits and have become cost effective enough that they can be used in consumer electronics.

The United States Department of Defense developed GPS with series of features that prevented high precision measurements unless the receiver is equipped with a special key. This helped ensure that enemies could not use the system against them. The military introduced “noise” into the satellite's clock data, which adds an inaccuracy into position calculations determined by the receiver. The military sends slightly erroneous orbital data to the satellites, which is transmitted back to receivers on the ground. This intentional degradation of the accuracy is referred to as Selective Availability (SA) error. Military receivers use a decryption key to remove the SA errors. These errors result in two classes of GPS service, Standard Positioning Service (SPS) and Precise Positioning System (PPS). GPS satellites transmit two different signals. The first signal is the Precision or P-code and the second signal is the Coarse Acquisition or C/A-code. The P-code is designed for authorized military users and provides PPS service. The military engages an encryption segment on the P-code called anti-spoofing (AS) to limit access to the P-code to authorized users. The C/A-code is designed for use by nonmilitary users and provides SPS service. The C/A-code is less accurate and easier to jam than the P-code. It is also easier to acquire. Selective availability is achieved by degrading the accuracy of the C/A-code. However, by 2006 the selective availability error is scheduled to be set to zero.

Other than intentional errors inserted by the DOD that are being removed from the GPS system, there are a variety of other error sources that vary with terrain and other factors. GPS satellite signals can he blocked by most materials. GPS signals have difficulty passing through buildings, metal, mountains, or trees. Leaves and jungle canopy can attenuate GPS signals so that they become unusable. In locations where at least four satellite signals with good geometry cannot be tracked with sufficient accuracy, GPS is almost unusable.

Differential GPS was developed in order to compensate for the inaccuracy of CPS readings. A high-performance CPS receiver is placed at a specific location. The information received by the receiver is then compared to the receiver's location and used to correct the SA satellite signal errors. A correction message is generated and transmitted to GPS users on a specific frequency such as 300 kHz. The correction message provides the CPS receiver information that allows it to correct for the SA error.

The reference site is sometimes referred to as a beacon, as it constantly transmits these difference coordinates. A differential GPS receiver is designed to receive both the GPS information and the beacon information. It generates a far more accurate estimate of its coordinates by applying the difference information to the GPS coordinates. The drawback to this is that the remote and reference receivers may not be using the same set of satellites in their computations. If this occurs, and the remote receiver uses the corrections the receiver may account for satellite errors that are not included in its own measurement data. These corrections can make the differential solution worse than the uncorrected GPS position. To prevent this error, an improved form of differential GPS involves the derivation of the corrections to the actual measurements made at the reference receiver to each satellite. By receiving all of the corrections independently, the remote receiver can pick and choose which are appropriate to its own observations. This method of DGPS is most widely used. Typically, the DGPS correction signal loses approximately 1 m of accuracy for every 150 km of distance from the reference station. The US Coast Guard and the Army Corps of Engineers have constructed a network of beacon stations that service the majority of the eastern United States, the entire length of both coastlines, the Great Lakes, and a vast majority of the continental United States. DGPS coverage also exists in many parts of the world including Europe, Asia, Australia, Africa, and South America.

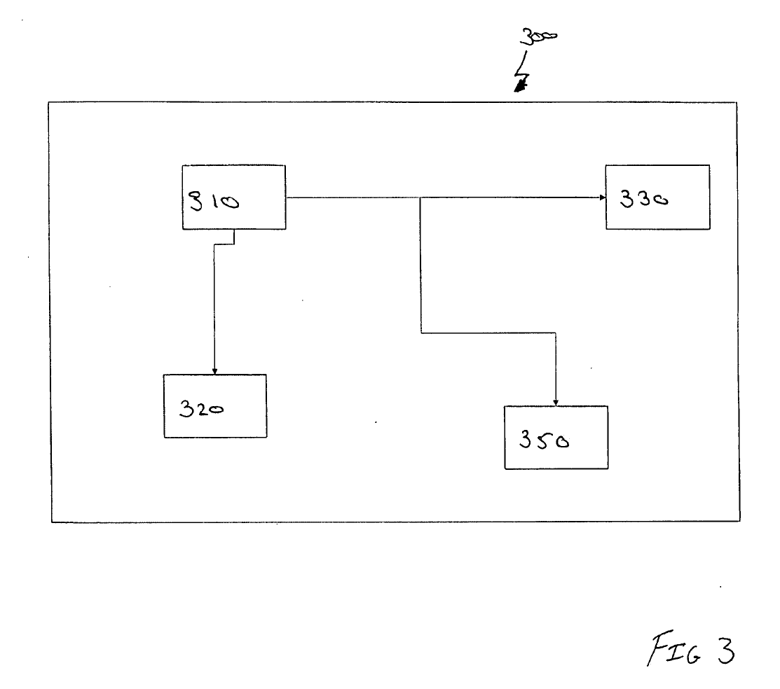

FIG. 3 is a simplified block diagram illustrating the components of the radar detector system 300 according to one embodiment of the present invention. Components illustrated in FIG. 3 are similar to those components illustrated in FIG. 2. Radar detector system includes at processor 310, a database of known locations 320, a plurality of radar sensitive detectors 330, and an interface device 350.

FIG. 4 is a flow diagram illustrating the steps executed by the present invention when determining the location of a radar source according to one embodiment of the present invention.

First the radar detector 300 receives a radar signal from the source. This is illustrated at step 410. The receipt of the signal sets in progress the steps for determining the location of the radar source. The signals are received at the each of the sensors at different times. The receipt of the signal at the first sensor is recorded as t₀. The receipt of the signals at the additional sensors is recorded as t₁, t₂, t₃, . . . tₙ. These times are used to determine the angle of the signal at each of the sensors. The determining of the angle is illustrated at step 420.

Based on the calculated angle the processor is able to project the location of the source of the signal. The system uses the angle from each of the sensors to perform a partial triangulation of the source of the signal. The system also uses the vehicle's current GPS coordinates to base the calculations off of. The system then knows the location of the vehicle and the distance and direction of the radar source. This information is then used to calculate the GPS coordinates of the radar source. The process of calculating the location of the source of the signal is illustrated at step 430.

Due to errors in the GPS system that are caused by any of the above described sources or inaccuracies, the system may employ intelligent position determining processes. These processes may look at a GPS coordinates on a map and integrate this knowledge with the determined location. If the determined location does not conform with the information on the map, the system may move the source of the signal to an appropriate location. For example, if the source of the signal appears to be a body of water, the system may move the source of the signal to the closest land mass to the water. The moved signal is then used in the comparison process.

Once the location of the source of the signal is known the system compares this location with locations stored in a database. As discussed above the database may be a local database of known signals, or it can be a sheared database. Regardless of the database's source, the location of the signal is compared with known locations. The comparison can include both location and type of signal. By using the type of signal the system is able to detect multiple sources emanating from the same location. This multiple signal is a common technique used by law enforcement to mask their own signals from users of radar detectors, as they are used to receiving a signal at a given location. This comparison of the signals is illustrated at step 440.

If there is a match between a known signal and the determined signal, the present invention will ignore the received signal. This is illustrated at step 445. However, in alternative embodiments the signal is not ignored, but presented to the user in a manner such that the user knows the signal is a matched signal. This can be accomplished through the use of a differential tone, or a different color of light. However, other differentiation methods can be used.

If there is no match between the source of the signal and the known locations, the user is provided with an alert. This alert can be audible, visual or both. This is illustrated at step 450. In one embodiment the location of the signal can be displayed on a map interface, such as the maps commonly associated with onboard navigation systems in modern automobiles. In this embodiment the location is shown as a dot on the screen. However, other methods of displaying the location can be used. In alternative embodiments, all known sources of signals can also be shown on the map. The user then can determine if the signal is a valid police radar signal, or if the signal is one to be ignored. This is illustrated at step 455.

If the user determines that the signal is a signal to be ignored the user interacts with the radar system at step 460. The user can press a button on the unit that will cause the location of the signal to be stored in the database. However, other methods of indicating that the signal is to be stored can be used. The coordinates of the signal are then stored in the database, and will be used in future analysis of signals.

If the user decides not to place the signal in the database, the signal is discarded from the short term memory at step 470. In additional embodiments the signal can be stored in long term memory for later analysis/retrieval and production of a comprehensive “speed trap” prediction map. However, in alternative embodiments the user can activate an alert feature on the radar unit. When the alert feature is activated the radar unit communicates through the wireless communications protocol to alert other users who are connected to the system of the location of police radar. In these embodiments the users of other units are provided the location of the signal. This location can be displayed on a map display on the vehicle, alerting the user to the exact location of the signal, prior to coming into the range of the signal.

FIG. 5 is a diagrammatic illustration of a vehicle including the radar detection and location system according to one embodiment of the present invention. In FIG. 5 vehicle 500 is shown with four sensors 510, 512, 514, and 516. Also illustrated in FIG. 5 is a radar source 520 emanating from a side of the vehicle.

Each of the sensors shown on the vehicle 500 are arranged such that there are at least two sensors that are not in line with each other. This arrangement: eliminates the possibility that all of the sensors would receive the radar signal at the same angle, thereby rendering the determination of the location of the source of the signal impossible.

In one embodiment of the present invention the sensors are not angle sensitive. As the sensors are not angle sensitive it is necessary to resolve the angle from which the signal is received. As discussed above the first sensor that receives the signal activates an internal clock that is used to determine the times at which the signal reaches each of the sensors. This time is indicated as t₀. The next sensor that receives the signal receives the signal at t₀. The remaining signals are received at t₂,t₃, etc. Based on the received time of the signal, the present invention can determine the angle at which the signal arrived at the sensors. This is determined according to the following equation,

$$angle = csc ( \frac{c ⋆ {t}_{n}}{y} )$$

where c is the speed of the radar signal, t is the time difference between t(0) and t(n) and y is the distance between the sensors. However if the sensors are able to determine the angle of receipt of the signal, the above process is omitted.

Once the angle the signal has been determined at at least two of the sensors, the present invention can then determine the location of the signal relative to the location of the vehicle. The location of the signal in one embodiment is determined using the law of sines. First the present invention generates a hypothetical triangle using the angle of incidence for the two sensors. The difference between 180 degrees and sum of the two angles yields the angle difference of the signal from the source. Once this angle is determined the location of the signal is calculated according to the following equation:

$$b = ( \frac{a ⋆ sin ( B )}{sin ( A )} )$$

where a is the distance between two sensors, A is the angle of the signal between the source and the two sensors, B is the angle between one of the sensors and the source of the signal, and b is the distance from sensor b and the source of the signal.

It should be noted that the angles that are calculated by the present invention are relative to the centerlines or baselines. However, other baselines can be used to determine the angles relative to these points. Further, the first sensor to receive the signal determines which baseline is used to calculate the angles.

Once distance b is determined by the system, the location of the signal is readily discemable. By taking the GPS location of sensor b, which is known relative to the GPS sensor (not shown), the system calculates the GPS location of the source of the signal based on the distance and angle of the signal from the sensor. As discussed above, this location can be displayed on a map and/or compared with information stored in the database of known signals.

In alternative embodiments of the present invention the detector monitors its location so as to comply with local laws regarding the use of radar detector devices. The detector will turn off its radar and or laser detection capability where local law prohibits such devices. In these embodiments, a text and/or audible warning can be displayed to the user indicating that these functions are off. The user input function and updating will remain in function so long as it does not violate local laws and regulations (i.e. at this time Virginia and the District of Columbia).

Further embodiments of the present invention can allow the user to indicate the location of non-radiating police presence through the use of the input device (i.e. police pacing traffic, or police vehicles that may be using an “instant on” form of detection) thus providing direction of travel and or point location of the police vehicle. In these embodiments, this information is provided to a central database at a central station via any known communication means. This information can then be provided out to other users via the same communication means so that these users will have access to the locations of positive and negative signals in real time.

To help control possible misuse of this feature, the system can limit the ability of users who input false information (as determined by accuracy rate of reporting or other method) so that their inputs will not hamper the accuracy of the present invention. The example, these users will have time delayed updates or risk/reliability level information tagged associated with their input. However, other methods can be used.

In yet another alternative embodiment the user is able to update the database with information from other users or the central station. The user can set the level of updating and type of updating that they wish to receive. For example, the user can decide to receive updates based upon the source and means by which the information was collected.

Although the present invention has been described with reference to preferred embodiments, workers skilled in the art will recognize that changes may be made in form and detail without departing from the spirit and scope of the invention.

What is claimed is:

1. A radar detector and location unit comprising:
at least three sensors configured to detect a radar signal, the at least three sensors being aligned in a non linear arrangement;
a position receiver configured to determine a position of the radar detector;
a data storage device configured to store data related to a location of a known series of radar emissions sites;
a processor connected to the at least three sensors, the position receiver and the data storage device;
wherein the processor is configured to determine the location of the radar emission based on a coordination between the at least three sensors and the position of the radar detector; and
wherein the processor is further configured to compare the location of the radar emission with locations in the know series of radar emissions sites.

2. The radar detector of claim 1 further comprising:
a map interface configured to display the location of the radar emission on the map.

3. A method of determining a location of a radar emission at a radar detector, comprising:
receiving a signal from the radar emission at at least three sensors configured to detect a radar signal;
receiving a signal indicative of the location of the radar detector;
determining the location of the radar emission based on the received signals from the sensors and the received signal indicative of location;
comparing the determined location with a list of known radar source locations; and
ignoring the radar emission if the determined location matches an entry in the list of known radar source locations.

4. The method of claim 3 further comprising;
displaying the location of the radar emission on a map.

5. The method of claim 4 further comprising:
highlighting on the map the location of an unidentified radar emission.
